(19) United States
(12) Patent Application Publication
(10) Pub. No.: US 2006/0062375 A1
(43) Pub. Date: Mar. 23, 2006

(54) System and method for providing product offers at a call center

(75) Inventors: Theodore Pasquale, Austin, TX (US); Kurt M. Joseph, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/948,089

(22) Filed: Sep. 23, 2004

(51) Int. Cl. H04M 3/00; H04M 5/00

(52) U.S. Cl. 379/265.12

(57) ABSTRACT

The disclosure is directed to a method of presenting product offers. The method includes receiving a call from a caller. The call has a purpose and call identification information. The method further includes determining a product offer based on the call identification information and directing the call to a call center agent based on the purpose. The call center agent has a skill level associated with the product offer. The method also includes providing an interface to the call center agent, the interface populated based on the skill level.

### FIELD OF THE DISCLOSURE

This disclosure in general relates to systems and methods for providing product offers.

### BACKGROUND

Receiving calls at call centers, such as customer support call centers and sales support call centers, represents an opportunity for contact with customers. Such contact with customers provides an additional opportunity to make offers for products and services. However, the typical call center designed to handle customer support calls may be responsible for supporting many products, and training call center agents to support all of the products is expensive and time consuming.

Given the large number of products, any one agent may not have the skills to offer or support that product or service. Moreover, each of the products or services may have a different protocol or method of implementing an accepted offer. For example, the call center agent may need to access a large number of disparate databases in order to implement different product or service offerings. For packaged or combined product and service offers, each package offering may have a different set of associated products or services and training would be useful for different offerings of the product or service.

Call centers often have great difficulty in training call center agents. Training takes time and is costly. In addition, turnover of call center agents tends to be high, resulting in high percentages of inexperienced call center agents manning call centers. As a result, call center agents may be asked to support products and services with which they are unfamiliar or on which they have not been trained.

Each of these difficulties leads to lower conversion rates of customers and longer call times associated with implementing accepted offers. As such, an improved method and service for providing a product offering would be desirable.

### BRIEF DESCRIPTION OF THE DRAWINGS

FIG. 1 includes a block diagram illustrating an exemplary customer support system.

FIGS. 2 and 3 include block diagrams illustrating exemplary call agent systems.

FIGS. 4, 5 and 6 include block flow diagrams illustrating exemplary methods for use by the customer support system, such as the exemplary system illustrated in FIG. 1.

FIGS. 7, 8 and 9 include general diagrams illustrating exemplary embodiments of a call center agent support interface.

### DETAILED DESCRIPTION OF THE DRAWINGS

In a particular embodiment, the disclosure is directed to a system and method for providing a product offering. A call from a caller is received at a call center. The call is associated with a specific purpose and has associated call information. One or more product or service offerings are selected based on the call information. The call is forwarded to a call center agent based on the purpose of the call. The call center agent has a skill level associated with each of the one or more selected product or service offerings. The call center agent is provided with an interface customized for or associated with the one or more product offerings and the interface may be adapted based on the skill level of the call center agent. In one particular embodiment, the purpose of the call and the offers being made to the caller are unrelated.

In one exemplary embodiment, the disclosure is directed to a method of presenting product offers. The method includes receiving a call from a caller. The call has a purpose and call identification information. The method further includes determining a product offer based on the call identification information and directing the call to a call center agent based on the purpose. The call center agent has a skill level associated with the product offer. The method also includes providing an interface to the call center agent, wherein the interface populated based on the skill level.

In another exemplary embodiment, the disclosure is directed to a method of presenting product offers. The method includes receiving a call at a call center. The call has associated call information. The method also includes determining a set of product offers based on the call information, wherein the number of product offers in the set of product offers is based on performance parameters associated with the call center. The method further includes directing the call to a call center agent terminal and providing an interface to the call center agent terminal. The interface is populated with information associated with the set of product offers.

In a further exemplary embodiment, the disclosure is directed to a call center agent terminal including computer accessible memory. The computer accessible memory stores a computer implemented interface. The computer implemented interface includes a control feature indicating an ordered set of selectable offers. of the computer-implemented interface also includes a selector control associated with a first selectable offer of the ordered set of selectable offers that when selected identifies information associated with the first selectable offer, an objection control associated with a common objection associated with the first selectable offer, and a customer response control to indicate a response of a customer to the first selectable offer.

In another exemplary embodiment, the disclosure is directed to a call center agent terminal including computer accessible memory. The computer accessible memory stores a computer implemented interface. The computer implemented interface includes a control feature indicating an ordered set of selectable offers. The computer-implemented interface also includes a selector control associated with a first selectable offer of the ordered set of selectable offers that when selected identifies information associated with the first selectable offer; information associated with an up-sell offer associated with the first selectable offer; and information associated with a down-sell offer of the first selectable offer.

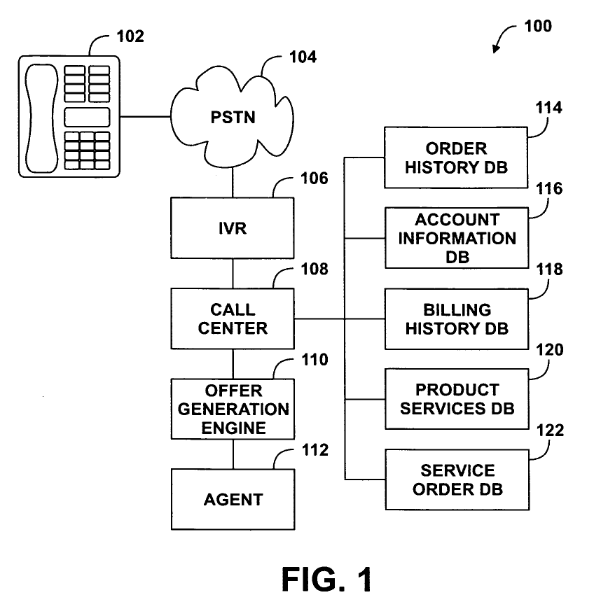

FIG. 1 is a block diagram including an illustration of an exemplary call system. For example, the call system may be useful in a customer support call center or in a sales call center. A caller places a call using telephone 102 through a public switch telephone network (PSTN) 104 to an interactive voice response (IVR) system 106. In an exemplary embodiment, the IVR system 106 determines a purpose of the call, such as through interactive voice response (IVR) menus and dual tone multi frequency (DTMF) responses. For example, the purpose of the call may be to acquire guidance for solving a technical problem, a problem with a billed item, or an interest in subscribing to a product or service. A caller may be prompted using a set of interactive menus to indicate the purpose or reason for the call. In addition, the IVR system 106 may determine information associated with the call, such as a caller's telephone number, customer identifier, or call origination location.

The call and the information associated with the call, such as the purpose of the call and the caller's telephone number, is transferred to a call center 108. In one particular embodiment, a single call center 108 is associated with the interactive voice response (IVR) system 106. In alternative embodiments, the interactive voice response (IVR) system 106 selects a call center 108 based on the purpose of the call. For example, the IVR system 106 may determine that the purpose of the call is associated with a billing question and forwards the call to a call center 108 dedicated to answering billing questions.

The call center 108 has access to a set of databases, such as an order history database 114, an account information database 116, a billing history database 118, a product services database 120, and a service order database 122. For example, the order history database 114 may include information about past product and service orders associated with the caller's account. The billing history database 118 may include information about bills and bill payment. The product services database 120 may include information about products and services available to a customer and information as to which products and services the customer subscribes. The service order database 122 may include information about pending service requests or repair requests associated with the customer's account.

The call center 108 may access the databases to retrieve additional information associated with the call. For example, the call information may include a caller's telephone number. The telephone number may be used to access the databases to determine an order history, an identity of the caller, a caller's location, payment history, products or services subscribed to by the caller, or active orders associated with the caller's account. In one particular embodiment, the caller's identifier, such as the telephone number, may be used to determine the active products and services associated with the customer's account. In another exemplary embodiment, the caller's telephone number may be used to determine whether the caller is delinquent on payments. In a further exemplary embodiment, the caller's identifier may be used to determine into which market segment the caller falls.

An offer engine 110 may use the additional information to generate a set of product and service offerings and order the set of product and service offerings. In one particular embodiment, the offer engine 110 may utilize a set of rules or an algorithm to provide a ranking of offers that are displayed visually to the agent in a manner consistent with their ranking. The algorithm may include weighted components that determine the order or ranking. The weighting of the components may be adjusted depending on business goals or product initiatives. In one exemplary embodiment, a set of offers may be determined based on the caller's predetermined or estimated disposition to accept such offers. Factors useful in determining disposition may include market segment information, previous orders, present subscriptions, and location. The offers may be ranked using weighting factors to align the offers with business goals and product initiatives.

For example, customers located in a specific region may have recently become eligible for a first service. In addition, customers subscribing to a specific set of services may be likely to subscribe to a second service and a new discount package may be offered that includes the set of services and a third service. When a customer calls who has the set of services and who is located in the specific region, the system may identify the first, second, and third services for offering to the customer. Offers associated with the first, second and third services may be ordered based on business goal or weighting of the importance of the products. For example, a business may desire to focus on building a customer base to support the first service in the specific region. In another example, the business may order the services based on the profit associated with each service. In a further example, the business may rank offers based on the likelihood that the customer will accept the offer or a product initiative factor, such as a ranking that may be provided by a product marketing organization.

In one exemplary embodiment, the product or service offerings are associated with communication services such as broadcast entertainment services, telecommunications products and services, broadband data network access products and services, and wireless network access products and services. In particular examples, the products or services may be selected from products and services related to satellite broadcast television, wireless telephones, landline telephone service, and broadband DSL network access. For example, using information such as a customer's market segment, product and service subscription information, residence location, and payment history, the offer generation engine 110 may determine that the customer should be offered broadband data network access, such as DSL access. In addition, the offer generation engine 110 may determine an ordered set of offers such as add-ons to a landline telecommunication service, and other services to which a particular customer is likely to subscribe. The offer generation engine 110 may also use information, such as marketing objectives, to determine particular product and service offerings to offer the customer. In one particular embodiment, the offer generation engine 110 utilizes performance characteristics associated with the call center 108 to determine the number and quality of offers to be made to a customer. For example, at peak call volume times or when waiting times or queue volume exceeds certain thresholds, the number of offers included in a set of offers and provided to a call center agent may be limited or reduced. Alternatively, at peak call times, product offerings that are easy to relay to the customer and easy to implement may be preferentially selected or preferentially positioned within an ordered set of offers.

The call is provided to an agent at a call center agent terminal 112 along with an interface associated with the call. For example, an agent may be selected based on the purpose of the call and the training of the call center agent for handling such calls. The agent may be a customer service agent associated with a specific product or service problem. In another exemplary embodiment, the call center agent may be a call center agent having a skill level or training in a particular product offering. In addition, the agent may have associated skill levels for other products, services, and customer support functions. In one exemplary embodiment, the call may be transferred to a call center agent having a particular skill in solving a specific customer support problem. However, the call center agent may have varying skills and training associated with different product and services offerings. As such, the system may provide an interface to the call center agent terminal 112 that is adapted based on the agent's skill level in a particular offering. For example, the call center 108 may include databases, tables, or sets of parameters that indicate which agents have received training in specific product offerings or that indicate skill levels associated with the agent for the specific product or service offerings. The interface may be adapted based on the skill levels stored by the call center 108.

In one particular embodiment, adapting the interface based on the agent's skill level permits adjustment of guidance provided to the agent based on the agent's proficiency at making specific product offerings or in implementing specific customer requests. For example, an agent may be well trained in wireless telecommunications offerings and less well trained in satellite broadcast offerings. In such an example, the system may provide an interface with details adapted to the agent's skill level, such as providing overview details to an experienced agent or providing detailed step-by-step instructions to an inexperienced or untrained agent.

During the call, the call center agent may receive and supply additional data via the interface. The additional data may be communicated to the offer engine 110 and the offers may be automatically reprioritized. In one particular embodiment, the reprioritization may provide a greater number of trade down or down sell options in the event a caller declines an offer.

In the event that a caller accepts an offer, the interface may include a location for indicating the response of the caller. In one exemplary embodiment, the offer may be associated with communications products. To implement the accepted offer, the agent may use tools and programs distinct from the interface. For example, in a communication offer environment, indication of offer acceptance may automatically lead to a launch of tools, such as third party verification tools, DSL qualification tools, wireless telephone ordering and qualification tools, ordering interfaces, account information interfaces, broadcast satellite ordering and qualification tools, and agent support tools.

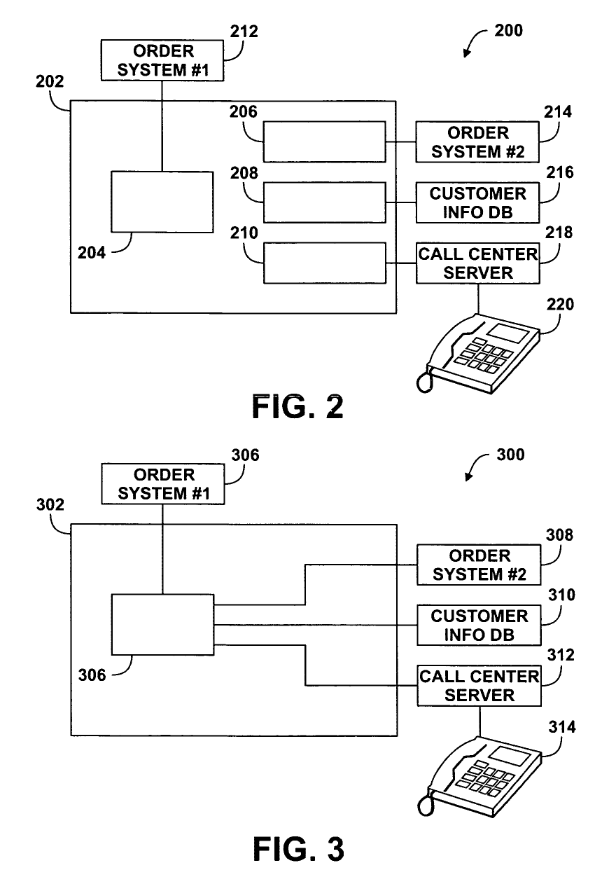

For large companies that offer a large number of product offerings and packaged deals, any one agent may have limited training in some of the product offerings and how to implement the product offerings once accepted by the customer. In particular, large companies may acquire new product lines through mergers and acquisitions. As a result, the disparate sales systems and order systems may be used by the call center agent to make product and service offers and implement accepted offers. FIG. 2 illustrates an exemplary system in which a call center agent is provided with multiple interfaces into various ordering systems and customer support systems. For example, FIG. 2 illustrates an exemplary system 200 that includes a call center agent terminal 202 having several interfaces connected to different databases and external systems. For example, an order system #1 212 may have an associated interface 204 accessible through the call center agent terminal 202. In other exemplary embodiments, an order system #2 214 has an associated interface 206, a customer information database 216 has an associated interface 208, and the call center server 218 has an associated interface 210.

A call 220 placed to the call center server 218 may result in associated offer information displayed in the interface 210. Based on the customer support or service purpose of the call 220 or product offerings accepted by the caller 220, the call center agent may access one or more of the interfaces, such as interfaces 204, 206 and 208. In one example, the call center agent may access information about the callers account via interface 208. In another example, if a particular order is requested or accepted, the call center agent may edit information associated with the customer in the customer information database 216 via interface 208 and order the product or service for the customer using interface 204 that accesses order system #1 212. In situations where products are offered in packaged offerings, the call center agent may order portions of the package through several different order systems, such as order systems 212 and 214, or different interfaces, such as interfaces 204 and 206.

For large systems, training call center agents in each of the product offerings is difficult. As such, the interface 210 may be adapted to provide instructions for each of the tasks associated with implementing any one order and for accessing each of the interfaces. The customer or call center agent interface 210 may be adapted based on the agent's training or skill level. For example, an agent trained on a specific product offering may be provided with fewer instructions or less detail than an agent not trained on a specific product offering. In one particular embodiment, indication of offer acceptance automatically launches tools associated with implementing the offer.

In alternative embodiments, the systems may be integrated or accessible by a single interface. For example, FIG. 3 illustrates an exemplary embodiment of a call center terminal 302 that has access to order system #1 306, order system #2 308, customer information database 310, and call center server 312 by an integrated interface 304. When a call 314 is made to the call center server 312, the information displayed in the call center interface 304 may be adapted to the skill level of the call center agent, such as providing different levels of detail and differing controls associated with each product offering and/or the implementation of each product offering. For example, more detailed instructions may be provided for each control element useful in implementing an accepted product offering for a call center agent having a low skill level or less training in a particular product. An integrated interface 304 may permit standardization of the interface to the relevant systems.

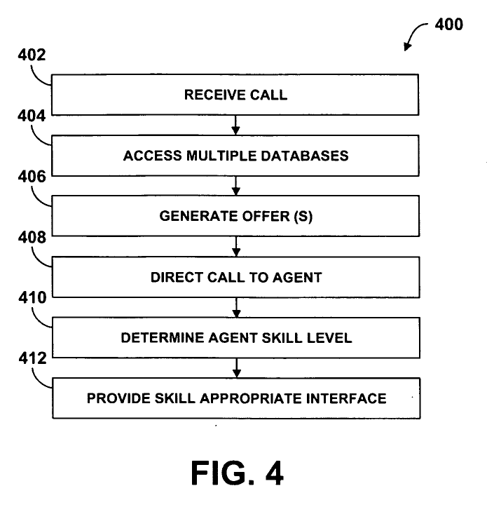

FIG. 4 illustrates an exemplary method for use by a call center system. A call is received, as shown at step 402. The call may have an associated purpose, such as customer support or a product request. For example, the call may be directed to an IVR system and the purpose of the call may be determined. In addition, the call has associated information, such as a customer identifier or a telephone number associated with the call.

The system accesses several databases, as shown in step 404, to acquire additional information about the call. For example, the system may determine payment histories, product and service descriptions, customer location, market segmentation, and pending order information. Based on this information, the system may generate a set of one or more offers, as shown at step 406. The offers may be compiled into an ordered set of offers.

For example, for telecommunications products and services, the system may select offerings, such as DSL service, caller ID, and cellular telephone service. For example, the system may access the databases and determine that the caller is in a region in which DSL service has recently become accessible. In another example, the system may determine that the caller has not subscribed to caller ID and that a new discount package is available to subscribers of features to which the caller has already subscribed. In a further example, the system may determine that the caller is a likely candidate for cellular and wireless telephone service based on the callers market segment and billing history. The offers may be ranked based on the revenue generated by each product, by the likelihood of offer acceptance, or a combination of factors.

The call is directed to a call center agent, as shown at step 408. For example, an agent may be selected based on the purpose of the call. In an alternative embodiment, an agent may be selected based on the product offerings generated, as shown at step 406. In one particular embodiment, the call may first be transferred from an interactive voice response (IVR) system to the call center. The IVR determines the particular purpose associated with the call and selects a call center based on that purpose. For example, a caller may be prompted to indicate the purpose of the call using a set of interactive menus. Further, the indicated purpose of the call may be transferred with the call.

When the agent is prepared to make a product offering, the system may determine the agent's skill level at making the product offering, as shown at step 410. For example, a particular agent may be well trained with respect to one particular product offering and less well trained with respect to a second product offering. In one particular embodiment, a call center system may include a database or set of parameters that indicate whether an agent has received training in specific product and service offers. The call center system may access the database to determine the agents skill level in relation to each of the one or more offers. The agent may be provided with a skill-appropriate interface, as shown at step 412. In one particular embodiment, the interface is populated based on the skill level of the agent with respect to a product or service offering. For example, a well-trained agent may be provided with a different interface associated with a selected offering than a less well-trained agent.

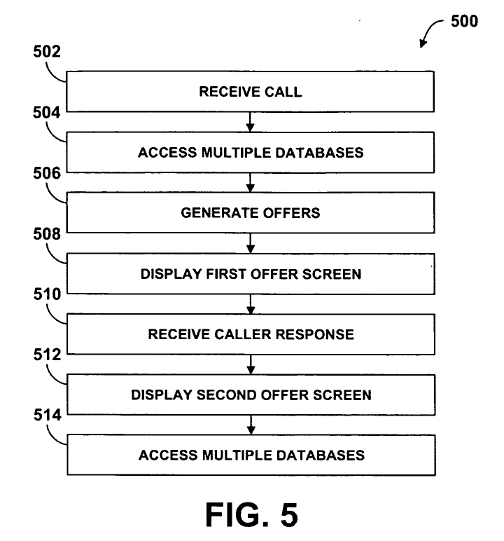

FIG. 5 illustrates another exemplary method 500 for interacting with the caller. A call is received, as shown at step 502, which has an associated call-identifier and call purpose. The system accesses multiple databases, as shown at step 504, to determine additional information about the call based on the call-identifier. A set of one or more offers is generated, as shown at step 506. These offers may be ordered based on the information acquired about the call from the databases. In one particular embodiment, the number and/or type of offers included in the set of one or more offers may be adapted based on call center performance characteristics, such as call volume, queue times, and peak volume times of day. In addition, the offers may include up-sell and down-sell options for each of the offers.

In one particular embodiment, a first offer interface is displayed, as shown at step 508. This first offer interface may be adapted based on an agent's skill level associated with the specific offer. The agent may interact with the customer and receive a response to the offer, as shown at step 510.

A second offer interface is displayed, as shown at step 512. In one particular embodiment the second offer is an up-sell offer interface, provided in response to a customer's accepting an offer. In another exemplary embodiment, the second offer interface is a down-sell offer interface associated with the customer's refusal of an offer. In a third exemplary embodiment, the offer interface is associated with a second product offer unrelated to the first offer interface and is adapted to the agent's skill level associated with that second product offer selected based on the generated set of offers. Once the offers are made or as offers are accepted, the system may access multiple databases, as shown at step 514. The databases may be the same databases accessed at step 504 or a different set of databases. For example, an agent may update customer information in several databases. In an alternative embodiment, the agent may access multiple interfaces to implement one or more product offerings that were accepted.

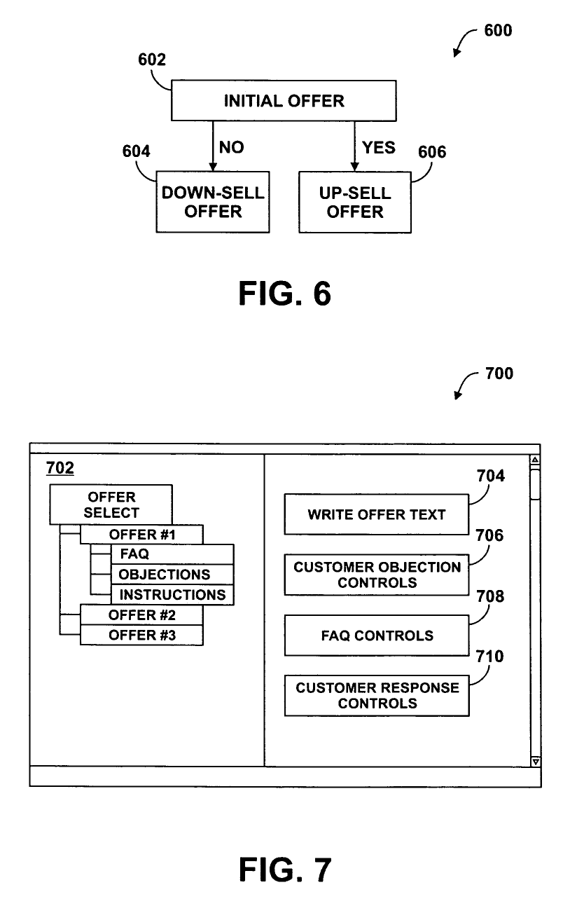

FIG. 6 depicts a particular embodiment in which an initial offer is made, as shown at step 602. If a customer accepts the offer, as shown at step 606, an interface is displayed to the agent that provides information about an up-sell offer. If the customer declines the offer, the system may display information associated with a down-sell offer, as shown in step 604. In one particular embodiment an agent skilled in making a particular offer may be provided all of the information associated with the initial offer, the down-sell offer, and the up-sell offer in a single interface. An agent unskilled in a particular offering may be provided with details associated with the initial offering, such as objections, frequently asked questions, and diagrams illustrating a particular product. The unskilled agent may also be provided with controls that indicate a customer's acceptance or declining of an offer and then a second interface is provided to the agent for either a down-sell offer or an up-sell offer.

FIG. 7 illustrates exemplary interfaces for use by a call center agent. The interface may, for example, include a detailed region 700 and a tree or guide region 702. In this particular example, an initial offer text 704 is displayed along with controls for reacting to customer objections 706, frequently asked question controls 708 and customer response controls 710.

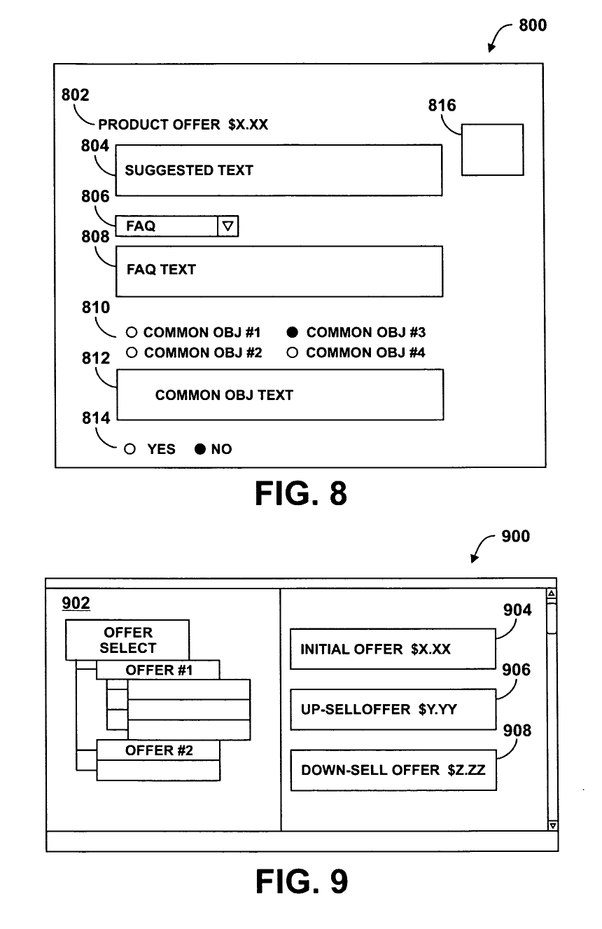

FIG. 8 illustrates an example of a detailed region of an interface provided to an unskilled or less well trained agent. For example, a product offer 802 including a price may be displayed. The unskilled agent may be provided with a suggested sales text 804 and a drop-down menu 806 for selecting a frequently asked question. In response to selecting a frequently asked question, the agent may be provided with a response text 808. In another exemplary embodiment, a set of controls 810 associated with common objections to an offer may be provided and, based on selection of one of the controls 810, may result in display of a response to common objection text 812. In addition, the call center agent may be provided with selection controls for indicating the customer's acceptance or declining of an offer 814. The controls, such as the frequently asked question controls, common objection controls, and selection controls, may be implemented as checkboxes, drop down menus, radio buttons, and interface controls. The interface may also include a picture or graphic 816 of the product and links to additional information about the product or service.

In an alternative example, a skilled agent may be provided with overview information associated with the set of offers, as illustrated in FIG. 9. For example, a skilled agent may be provided with a product offering interface portion 900 that includes a simplified product offering text 904 as well as overview information of up-sell offers 906 and down-sell offers 908. The skilled agent may also be provided with a tree structure control 902 that allows quick access to additional information such as common objections, frequently asked questions, and other offers unrelated to the first offer. As such, a more skilled agent may be provided with overview information and access to detailed information, providing greater flexibility, control and accessibility to information associated with a particular offer.

On the other hand, a less skilled agent may be provided with more detailed information about a particular product offering, guiding that unskilled agent through a product offering and improving their productivity, offer success rate and skill level.

In one particular embodiment, the skill-based interface reduces time and resource usage associated with agent development of offers and saves minutes on each call. In another exemplary embodiment, the guided interface reduces learning curves for new agents or agents inexperienced in a particular product or service. More experienced agents can retain creativity in how they make offers and have a greater flexibility in how they present and organize offers. Lower performing or inexperienced agents can be guided through offer processes. In addition, the offer engine may focus attention on offers that drive business goals. For example, when a telecommunications business is interested in increasing sales in broadband Internet service, broadband Internet services may be preferentially selected and weighted by an offer engine and the agent may be guided based on their skill level to make the offer to a customer. In general, a product offering may be considered an offer for a physical product or an offer for a service or service package.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of presenting product offers, the method comprising:
receiving a call from a caller, the call having a purpose and call identification information;
determining a product offer based on the call identification information;
directing the call to a call center agent based on the purpose, the call center agent having a skill level associated with the product offer; and
providing an interface to the call center agent, the interface populated based on the skill level.

2. The method of claim 1, further comprising determining the purpose associated with the call using an interactive voice response (IVR) system.

3. The method of claim 1, wherein the product offer is different from the purpose of the call.

4. The method of claim 1, further comprising determining an up-sell product offer associated with the product offer.

5. The method of claim 1, further comprising determining a down-sell product offer associated with the product offer.

6. The method of claim 5, wherein the interface includes a control that indicates a declined offer, the method further comprising providing information associated with the down-sell product in response to receiving an indication of the declined offer.

7. The method of claim 1, further comprising accessing a plurality of databases using the call identification information before determining the product offer.

8. The method of claim 7, wherein the plurality of databases are selected from a group consisting of a service order database, a product service database, an account information database, and a billing history database.

9. The method of claim 1, wherein the interface includes a control element associated with common objections, the method further comprising providing response information based on activation of the control element.

10. The method of claim 1, wherein the product offer is associated with communications related products and services.

11. The method of claim 10, wherein the communications related products and services are associated with broadband network access.

12. The method of claim 10, wherein the communications related products and services are associated with wireless telephones.

13. The method of claim 10, wherein the communications related products and services are associated with broadcast entertainment.

14. The method of claim 10, wherein the communications related products and services are associated with telecommunications.

15. A method of presenting product offers, the method comprising:
receiving a call at a call center, the call having associated call information;
determining a set of product offers based on the call information, wherein the number of product offers in the set of product offers is based on performance parameters associated with the call center;
directing the call to a call center agent terminal; and
providing an interface to the call center agent terminal, the interface populated with information associated with the set of product offers.

16. The method of claim 15, further comprising accessing a set of databases before determining the set of product offers.

17. The method of claim 15, further comprising determining an order of the set of product offers after determining the set of product offers.

18. The method of claim 17, wherein determining the order of the set of product offers includes evaluating a set of weighting factors associated with the product offers.

19. The method of claim 18, wherein the set of weighting factors includes a product initiative factor.

20. The method of claim 15, wherein the interface is populated based on an agent skill level.

21. The method of claim 15, further comprising determining a purpose of the call using an interactive voice response system.

22. The method of claim 21, wherein directing the call to the call center agent terminal is based on the purpose of the call.

23. The method of claim 15, wherein at least one product offer within the set of product offers is associated with a communications related product or service.

24. The method of claim 23, wherein the communications related product or service is associated with broadband network access.

25. The method of claim 23, wherein the communications related product or service is associated with wireless telephones.

26. The method of claim 23, wherein the communications related product or service is associated with broadcast entertainment.

27. The method of claim 23, wherein the communications related product or service is associated with telecommunications.

28. A call center agent terminal including computer accessible memory, the computer accessible memory storing a computer implemented interface, the computer implemented interface comprising:
a control feature indicating an ordered set of selectable offers; and
a selector control associated with a first selectable offer of the ordered set of selectable offers that when selected identifies:
information associated with the first selectable offer;
an objection control associated with a common objection associated with the first selectable offer; and
a customer response control to indicate a response of a customer to the first selectable offer.

29. The call center agent terminal of claim 28, wherein the information associated with the first selectable offer is adapted based on a skill level of a call center agent.

30. The call center agent terminal of claim 28, wherein the computer implemented interface further comprises a frequently asked question control.

31. The call center agent terminal of claim 28, wherein the computer implemented interface is configured to provide information associated with an up-sell offer based on the response of the customer to the first selectable offer.

32. The call center agent terminal of claim 28, wherein the computer implemented interface is configured to provide information associated with a down-sell offer based on the response of the customer to the first selectable offer.

33. The call center agent terminal of claim 28, wherein the interface is configured to display information associated with a second selectable offer of the ordered set of selectable offers, information associated with an up-sell offer associated with the second selectable offer, and information associated with a down-sell offer of the second selectable offer when a second selector control associated with the second selectable offer is selected and the call center agent has a particular skill level associated with the second selectable offer

34. A call center agent terminal including computer accessible memory, the computer accessible memory storing a computer implemented interface, the computer implemented interface comprising:
a control feature indicating an ordered set of selectable offers; and
a selector control associated with a first selectable offer of the ordered set of selectable offers that when selected identifies:
information associated with the first selectable offer;
information associated with an up-sell offer associated with the first selectable offer; and
information associated with a down-sell offer of the first selectable offer.

35. The call center agent terminal of claim 34, wherein the information associated with the first selectable offer is adapted based on a skill level of a call center agent, the skill level associated with the second selectable offer.

36. The call center agent terminal of claim 34, wherein, when the call center agent has a particular indicated skill level associated with a second selectable offer of the ordered set of selectable offers, the interface is configured to display information associated with the second selectable offer, an objection control associated with a common objection associated with the second selectable offer, and a customer response control operable to indicate a response of a customer to the second selectable offer.
